(19) United States
(12) Patent Application Publication
(10) Pub. No.: US 2023/0378845 A1
(43) Pub. Date: Nov. 23, 2023

(54) Noise reduction and shock absorption structure for tubular motor

(71) Applicant: Harda Intelligent Technologies Co., Ltd., Fujian (CN)

(72) Inventor: KeSheng PENG, Fujian (CN)

(21) Appl. No.: 18/228,682

(22) Filed: Aug. 1, 2023

(30) Foreign Application Priority Data
Aug. 3, 2022 (CN) 202222036353.X

(51) Int. Cl. H02K 5/24; H02K 7/00

(52) U.S. Cl. CPC H02K 5/24; H02K 7/003; H02K 2207/03

(57) ABSTRACT

A noise reduction and shock absorption structure for a tubular motor, including a motor casing, a motor body inside the motor casing with a front end thereof connected to a transmission shaft, an output support at a front end of the motor casing, an output shaft passing through the output support, and a fixing seat inside the motor casing; a first damping assembly is provided between the transmission shaft and the output shaft, and a second damping assembly is provided between the rear end of the motor body and the fixing seat, thereby achieving cushioning and vibration damping effects and therefore improving the quality of the tubular motor.

### BACKGROUND OF THE INVENTION

The present invention relates to the technical field of tubular motors, and in particular to a noise reduction and shock absorption structure for tubular motor.

A tubular motor consists of three main sections: stroke, motor, and deceleration, all working inside a circular tube. The stroke section controls the upper and lower limits of the motor, the motor section is responsible for motor rotation, while the deceleration section mostly uses planetary reduction to slow down the motor speed and increase output torque.

Tubular motors are mainly used for electric rolling doors, where the motor is hidden inside a rolling tube and is controlled by a remote controller. As the motor rotates, it drives a transmission shaft to rotate and thus roll up or down the curtain. When being rolled up, the curtain is wound on the rolling shaft; when being rolled down, the curtain slides down along an inner side of a guide rail.

However, high-speed rotation of the motor causes frequent shaking, which is transmitted to the motor casing. As a result, vibration and noise occur between the motor casing and the rolling shaft, thereby creating a bad user experience. A current solution is to provide a buffer piece between the motor and the motor casing to absorb the vibration. However, this only solves the problem of vibration transmission between the motor and the motor casing. In fact, to prevent the motor's output shaft from deviating during operation, an output bracket and a fixing seat are installed on two ends of the motor respectively to keep both ends of the motor relatively fixed with the motor casing. This means that there is a rigid connection between the two ends of the motor and the motor casing. However, this rigid connection is easily affected by the preciseness in the assembly of different components, and can also cause vibration. Therefore, the noise reduction effect of an existing tubular motor is still not ideal and cannot be used in situations that require silent operation.

### BRIEF SUMMARY OF THE INVENTION

The present invention aims to provide a noise reduction and shock absorption structure for a tubular motor, which solves the problems existing in the prior art and achieves better noise reduction and shock absorption effects, thus improving the quality of the tubular motor.

In order to achieve the above objects, the present invention adopts the following technical solutions:

A noise reduction and shock absorption structure for a tubular motor, comprising a motor casing, a motor body, an output support, an output shaft, a fixing seat, a first damping assembly, and a second damping assembly;

the motor body is provided inside the motor casing; a front end of the motor body is connected to a transmission shaft to transmit motions;

the output support is embedded at a front end of the motor casing;

the output shaft is rotatable and passes through the output support;

the fixing seat is embedded within the motor casing;

the first damping assembly is provided between the transmission shaft and the output shaft;

the second damping assembly is provided between a rear end of the motor body and the fixing seat;

the first damping assembly comprises a first connecter and a second connecter both made of hard materials, and a first buffer piece and a second buffer piece both made of soft materials; the transmission shaft, the first connecter, the second connecter, and the output shaft are connected coaxially in sequence;

the first buffer piece is provided at a connecting portion between the transmission shaft and the first connecter, and the second buffer piece is provided at a connecting portion between the first connecter and the second connecter;

the second damping assembly comprises a third connecter and a fourth connecter both made of hard materials, and a third buffer piece and a fourth buffer piece both made of soft materials; the rear end of the motor body, the third connecter, the fourth connecter, and the fixing seat are connected coaxially in sequence;

the third buffer piece is provided at a connecting portion between the third connecter and the fourth connecter, and the fourth buffer piece is provided at a connecting portion between the fourth connecter and the fixing seat.

The hard materials are metals or high-strength plastics; the soft materials are rubber and silicone.

An input end of the first connecter is a first spline hole, and a circumferential surface of the transmission shaft is sleeved by a fifth connecter made of a hard materials; an outer shape of the first buffer piece matches with a shape of the first spline hole; an outer shape of the fifth connecter matches with a shape of an inner cavity of the first buffer piece, and an inner cavity of the fifth connecter matches with a shape of the transmission shaft.

An output end of the first connecter is a first spline head, and a first spline groove corresponding to the first spline head is formed on the second buffer piece.

Preferably, an end surface of the second connecter facing towards the first connecter is recessed to form a second spline groove; an end of the second spline groove away from the first connecter is stepped to form a through hole in communication with the second spline groove for the output shaft to pass through; a limiting plate is provided at an end of the output shaft to abut against an end surface of the second buffer piece; first limiting grooves on which the limiting plate is slidable along an axial direction of the second spline groove are formed on side walls of the second spline groove; the first limiting grooves extend to the end of the second spline groove away from the first connecter.

Preferably, a length of the first spline groove is greater than a length of the first spline head.

A shaft rotation hole is formed in the output support extending along an axis of the output support; the output shaft passes through the shaft rotation hole and is rotatable inside the shaft rotation hole; a plurality of damping rings are provided between a circumferential surface of the output shaft and an inner wall of the shaft rotation hole.

A speed reduction device is provided on an output end of the motor body; an input end of the speed reduction device is connected with a rotating shaft of the motor body to achieve motion transmission; an output end of the speed reduction device is connected with the transmission shaft to achieve motion transmission.

A plurality of first limiting plates are provided around a peripheral edge of an end surface of the rear end of the motor body; second limiting grooves corresponding to the first limiting plates are formed circumferentially around an end portion of the third connecter facing towards the motor body; the first limiting plates are inserted into the second limiting grooves respectively.

A second spline head is provided at one end of the third connecter facing towards the fourth connecter; a second spline hole is formed at one end of the third buffer piece facing towards the third connecter, and a third spline head is provided at another end of the third buffer piece facing towards the fourth connecter; and the second spline hole extends through an end surface of the third spline head; a third spline hole is formed at one end of the fourth connecter facing towards the third connecter; the second spline head is sleeved by the second spline hole, and the third spline head is sleeved by the third spline hole.

Preferably, a first stepped platform is provided on a circumferential surface of the third buffer piece, the third spline head protrudes from an end surface of the first stepped platform, and an end surface of the fourth connecter abuts against the first stepped platform.

Preferably, a plurality of second limiting plates are provided on a circumferential surface of the third connecter; third limiting grooves corresponding to the second limiting plates are formed on an end surface of the third buffer piece facing towards the third connecter; the second limiting plates are inserted into the third limiting grooves respectively.

A fourth spline head is provided at one end of the fourth connecter facing towards the fixing seat; a fourth spline hole and a fifth spline head are provided at two ends of the fourth buffer piece respectively; the fourth spline hole extends through an end surface of the fifth spline head; a fifth spline hole is formed at one end of the fixing seat facing towards the fourth connecter; the fourth spline head is sleeved by the fourth spline hole, and the fifth spline head is sleeved by the fifth spline hole.

Preferably, a second stepped platform is provided on a circumferential surface of the fourth connecter, and the fourth spline head protrudes from an end surface of the second stepped platform; a third stepped platform is provided on a circumferential surface of the fourth buffer piece, and the fifth spline head protrudes from an end surface of the third stepped platform; an end surface of the fourth buffer piece abuts against the second stepped platform, and an end surface of the fixing seat abuts against the third stepped platform.

A circumferential surface of the fixing seat is sleeved with a first damping sleeve, and the first damping sleeve is elastically fitted between the fixing seat and the inner wall of the motor casing.

A third damping assembly is provided between a circumferential surface of the motor body and the inner wall of the motor casing; the third damping assembly comprises a sealing tube sleeving around the circumferential surface of the motor body, and a plurality of second damping sleeves sleeving around a circumferential surface of the sealing tube; the second damping sleeves are elastically fitted between the circumferential surface of the sealing tube and the inner wall of the motor casing.

Preferably, fourth limiting grooves accommodating the second damping sleeves respectively are formed on the circumferential surface of the sealing tube.

Preferably, a plurality of stripes oriented along the axial direction of the tubular motor are formed on a circumferential surface of each of the second damping sleeves, and the stripes are formed as protrusions or recesses on the circumferential surface of each of the second damping sleeves.

After the above technical solutions are adopted, the present invention has the following technical effects:

(1) The present invention achieves cushioning and vibration damping effects by providing a first damping assembly between the transmission shaft and the output shaft at the front end of the motor body, and a second damping assembly between the rear end of the motor body and the fixing seat. Both the first damping assembly and the second damping assembly are three-stage buffering connection structures. These structures are applied at both ends of the motor body to provide cushioning and vibration damping effects during progressive power and motion transmission process and the process of components fixation and connection.

(2) Compared to the traditional structure where there are rigid connections and motion transmissions between the motor body, the output support, and the fixing seat, the three-stage buffering connection structures that provide elastic connection and motion transmission can effectively reduce or even eliminate vibrations at each stage of connection and motion transmission, preventing noise, thereby enhancing the noise reduction and vibration damping effect between the input end of the tubular motor and the motor casing. As a result, the quality of the tubular motor is improved and thus it can be used in scenarios where silent operation is required.

### BRIEF DESCRIPTION OF THE DRAWINGS

FIG. 1 is a perspective view of the overall specific embodiment according to the present invention;

FIG. 2 is an exploded view of the overall specific embodiment according to the present invention;

FIG. 3 is an exploded view of the motor part of the specific embodiment according to the present invention;

FIG. 4 is a perspective view of the fixing seat of the specific embodiment according to the present invention;

FIG. 5 is exploded view I of the first damping assembly, the output support, and the output shaft of the specific embodiment according to the present invention;

FIG. 6 is exploded view II of the first damping assembly, the output support, and the output shaft of the specific embodiment according to the present invention;

FIG. 7 is exploded view I of the second damping assembly of the specific embodiment according to the present invention;

FIG. 8 is exploded view II of the second damping assembly of the specific embodiment according to the present invention;

FIG. 9 is a cross-sectional view of the overall specific embodiment according to the present invention;

FIG. 10 is an enlarged view of portion A in FIG. 9; and

FIG. 11 is an enlarged view of portion B in FIG. 9.

### DETAILED DESCRIPTION OF THE INVENTION

In order to further explain the technical solutions of the present invention, the present invention will be explained in detail by specific embodiments.

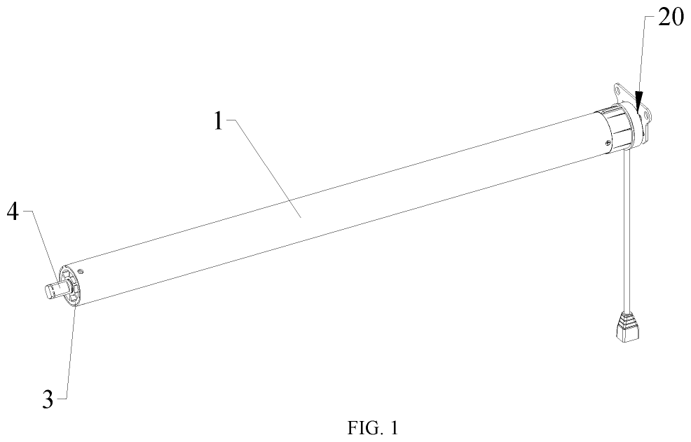

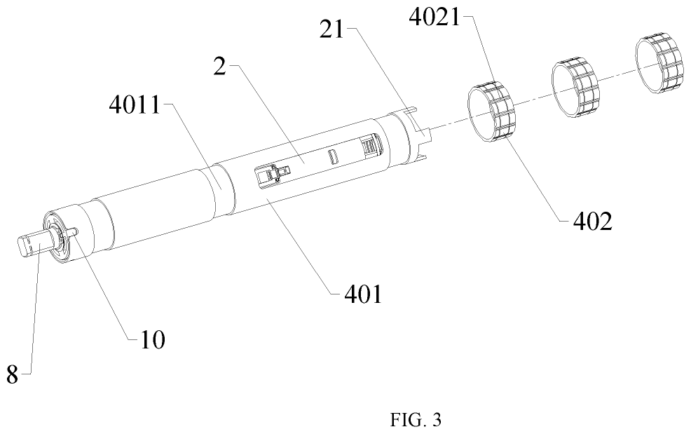

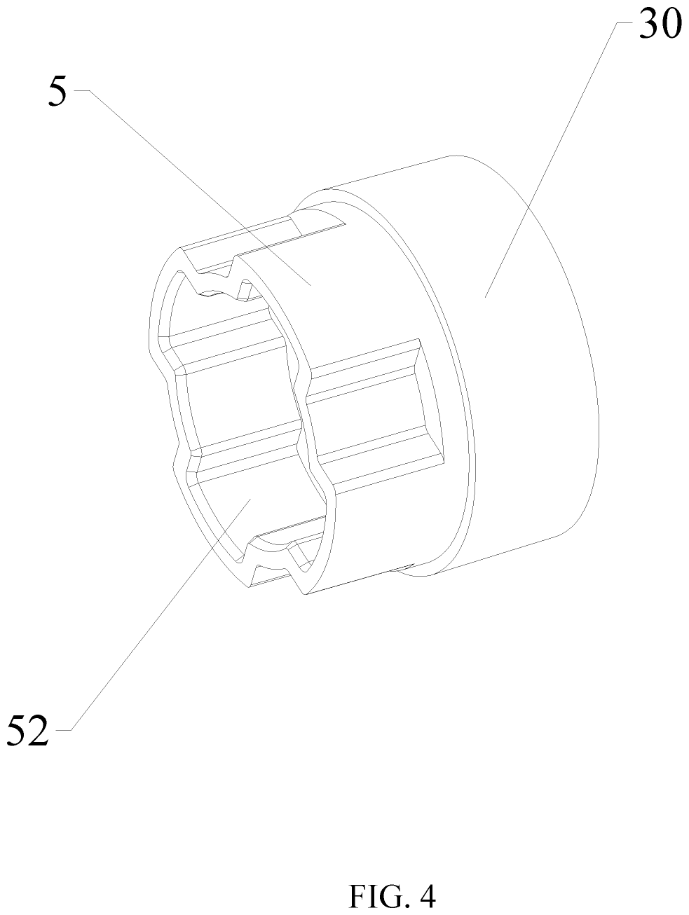

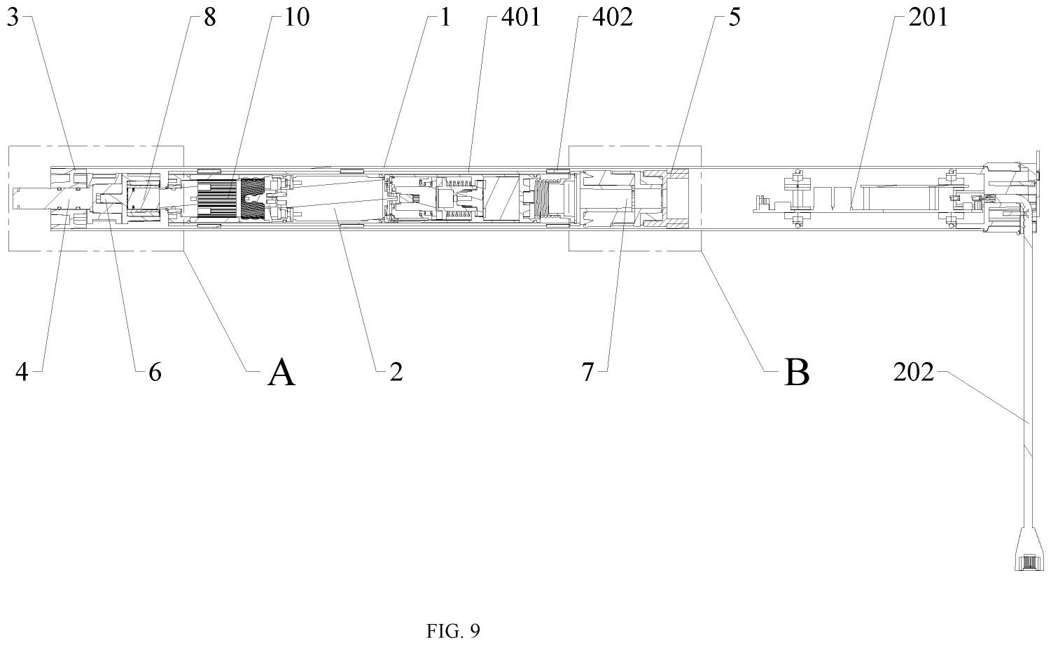

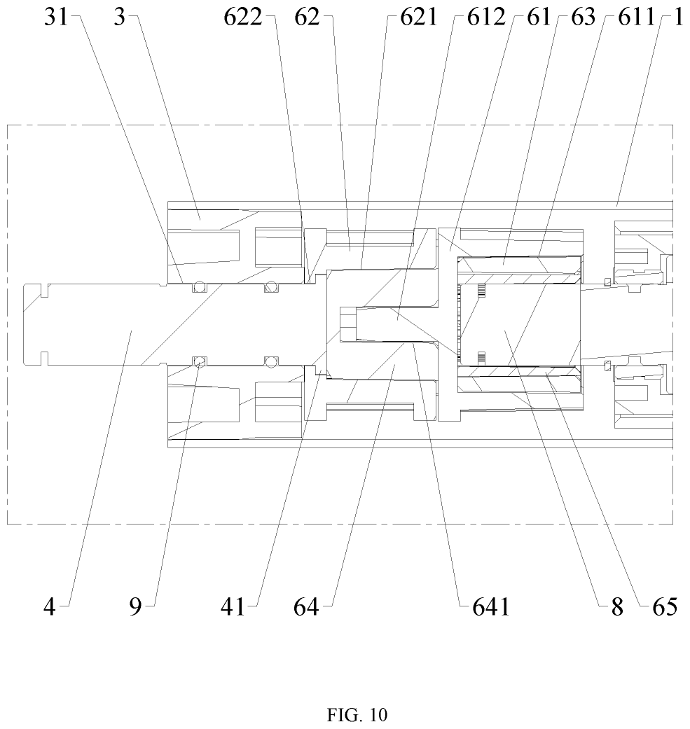

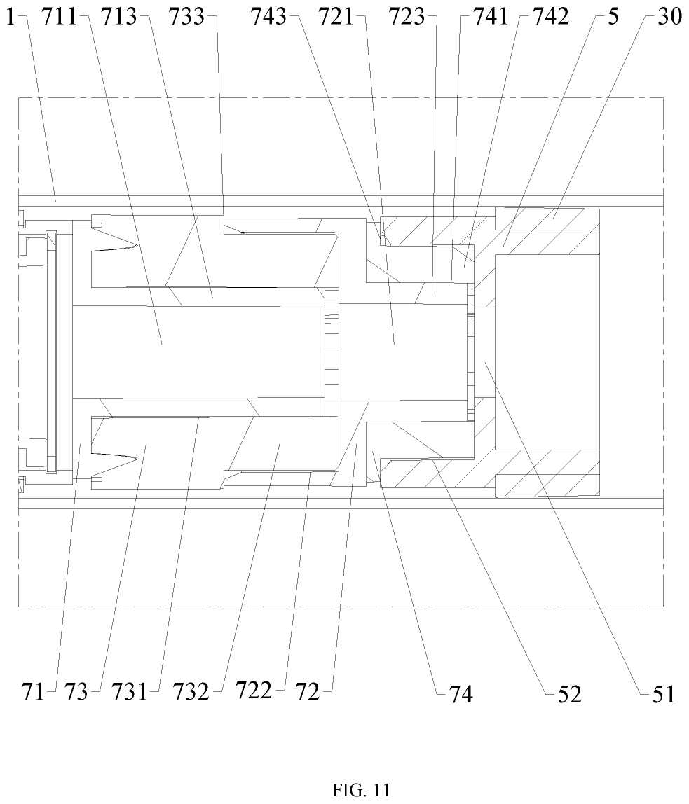

Referring to FIGS. 1 to 11, the present invention discloses a noise reduction and shock absorption structure for a tubular motor, which comprises a motor casing 1, a motor body 2, an output support 3, an output shaft 4, a fixing seat 5, a first damping assembly 6, and a second damping assembly 7;

the motor body 2 is provided inside the motor casing 1; a front end of the motor body 2 is connected to a transmission shaft 8 to transmit motions;

the output support 3 is embedded at a front end of the motor casing 1;

the output shaft 4 is rotatable and passes through the output support 3, and is configured to connect external devices driven by the tubular motor, such as a rolling shaft of a rolling door;

the fixing seat 5 is embedded within the motor casing 1 and is positioned proximal to a rear end of the motor casing 1;

the first damping assembly 6 is provided between the transmission shaft 8 and the output shaft 4; the second damping assembly 7 is provided between a rear end of the motor body 2 and the fixing seat 5;

the first damping assembly 6 comprises a first connecter 61 and a second connecter 62 both made of hard materials, and a first buffer piece 63 and a second buffer piece 64 both made of soft materials; the transmission shaft 8, the first connecter 61, the second connecter 62, and the output shaft 4 are connected coaxially in sequence to enable power transmission from the motor body 2 to the output shaft 4; the first buffer piece 63 is provided at a connecting portion between the transmission shaft 8 and the first connecter 61, and the second buffer piece 64 is provided at a connecting portion between the first connecter 61 and the second connecter 62, thus providing soft connections as well as cushioning and vibration damping effects;

the second damping assembly 7 comprises a third connecter 71 and a fourth connecter 72 both made of hard materials, and a third buffer piece 73 and a fourth buffer piece 74 both made of soft materials; the rear end of the motor body 2, the third connecter 71, the fourth connecter 72, and the fixing seat 5 are connected coaxially in sequence to achieve an indirect coaxial connection between the motor body 2 and the fixing seat 5, thereby preventing the motor body 2 from angular displacement after being installed inside the motor casing 1; the third buffer piece 73 and the fourth buffer piece 74 are provided at a connecting portion between the third connecter 71 and the fourth connecter 72 and at a connecting portion between the fourth connecter 72 and the fixing seat 5 respectively, thereby preventing direct contact between the third connecter 71 and the fourth connecter 72 and between the fourth connecter 72 and the fixing seat 5.

Specific embodiments of the present invention are described below.

The above-mentioned hard materials are materials that are hard and not easy to deform, such as metals and high-strength plastics. Said high-strength plastics can be PA66+33% GF (a composite material of nylon 66 and glass fiber, which is an existing material); the above-mentioned soft materials are elastic materials able to provide buffering effect, such as rubber and silicone, and a specific example of soft materials is TPV45° (thermoplastic vulcanizate with a shore hardness of 45, which is an existing material). In the present embodiment, the third connecter 71 and the third buffer piece 73, as well as the fourth buffer piece 74 and the fixing seat 5, are in each case formed integrally as a whole by using overmolding technique in order to enhance the connection strength, reduce components required during assembly, and increase assembly efficiency.

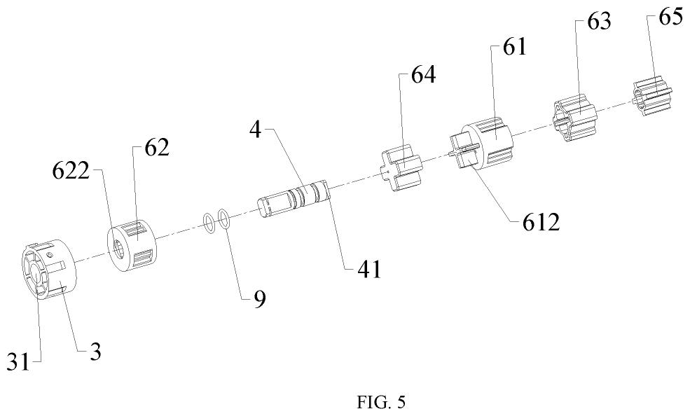

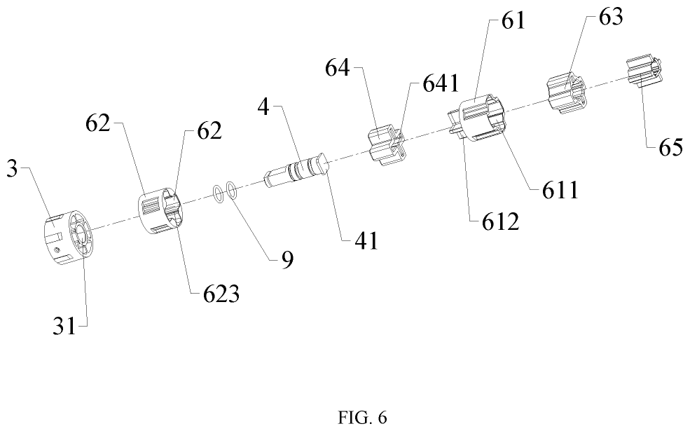

Referring to FIGS. 5 and 6, the aforementioned transmission shaft 8, the first connecter 61, the second connecter 62, and the output shaft 4 are connected coaxially using spline connection. Specifically, a circumferential surface of the transmission shaft 8 is sleeved by the first buffer piece 63; an input end of the first connecter 61 sleeves the first buffer piece 63; the second buffer piece 64 sleeves a circumferential surface and an end surface of an output end of the first connecter 61; the second connecter 62 sleeves the second buffer piece 64, and an end of the output shaft 4 abuts against an end surface of the second buffer piece 64.

In some embodiments of the aforementioned first damping assembly 6, the input end of the first connecter 61 is a first spline hole 611, and the circumferential surface of the transmission shaft 8 is sleeved by a fifth connecter 65 made of a hard material; an outer shape of the first buffer piece 63 matches with a shape of the first spline hole 611; an outer shape of the fifth connecter 65 matches with a shape of an inner cavity of the first buffer piece 63, and an inner cavity of the fifth connecter matches with a shape of the transmission shaft 8. Since the transmission shaft 8 is generally in a regular shape, such as a cross section of a running track in an athletics field (i.e. two arcs at top and bottom, connected by two vertical edges at left and right), the additional arrangement of the fifth connecter 65 allows for adaptation of the transmission shaft 8 to the first buffer piece 63 which is in a different shape, thus fulfilling the requirements for spline connection.

In some embodiments of the aforementioned first damping assembly 6, the output end of the first connecter 61 is a first spline head 612, and a first spline groove 641corresponding to the first spline head 612 is formed on the second buffer piece 64. In this embodiment, a cross section of the first spline head 612 has a cross shape.

Furthermore, an end surface of the second connecter 62 facing towards the first connecter 61 is recessed to form a second spline groove 621; an end of the second spline groove 621 away from the first connecter 61 is stepped to form a through hole 622 in communication with the second spline groove 621 for the output shaft 4 to pass through; a limiting plate 41 is provided at the end of the output shaft 4 abutting against the end surface of the second buffer piece 64; first limiting grooves 623 for the limiting plate 41 to slide along an axial direction of the second spline groove 621 are formed on side walls of the second spline groove 621; the first limiting grooves 623 extend to the end of the second spline groove 621 away from the first connecter 61, thereby allowing the assembly of the output shaft 4 in the second connecter 62. During assembly, the output shaft 4 is first inserted into the second spline groove 621 from the end of the second connecter 62 facing towards the first connecter 61, and during insertion of the output shaft 4, the limiting plate 41 slides on the first limiting grooves 623, then the output shaft 4 passes through the through hole 622, and the limiting plate 41 comes into contact with a stepped portion at the end of the second spline groove 621 away from the first connecter 61; next, the first spline head 612 sleeved with the second buffer piece 64 is inserted into the second spline hole 621 and abuts against the limiting plate 41, thereby achieving sequential key-joint connections between the first connecter 61, the second connecter 62, and the output shaft 4.

Meanwhile, a length of the first spline groove 641 is greater than a length of the first spline head 612, allowing a gap to be formed between the first spline head 612 and a bottom wall of the first spline groove 641after the first spline head 612 is inserted into the first spline groove 641. During assembly, the first spline head 612 cannot abut against the bottom wall of the first spline groove 641, so that more space is given for deformation at an end of the second buffer piece 64 abutting against the output shaft 4 to achieve better vibration damping effects. Also, the gap between the first spline head 612 and the bottom wall of the first spline groove 641 contains air which dampens transmission of noise, thereby achieving the purpose of noise reduction.

A shaft rotation hole 31 is formed extending along an axis of the output support 3; the output shaft 4 passes through the shaft rotation hole 31 and is rotatable inside the shaft rotation hole 31; a plurality of damping rings 9 are provided between a circumferential surface of the output shaft 4 and an inner wall of the shaft rotation hole 31. The damping rings 9 are elastically fitted between the output shaft 4 and the output support 3, thereby preventing complete rigid contact between the output shaft 4 and the output support 3. This reduces the impact on the output support 3 when the output shaft 4 rotates, thereby reducing the noise generated by the product.

A speed reduction device 10 is provided on an output end of the motor body 2; an input end of the speed reduction device 10 is connected with a rotating shaft of the motor body 2 to achieve motion transmission; an output end of the speed reduction device 10 is connected with the transmission shaft 8 to achieve motion transmission, thus enabling the transmission shaft 8 to connect to the motor body 2 through the speed reduction device 10. This arrangement achieves a reduction in speed from the motor body 2 to the transmission shaft 8, increases torque, and better accommodates the typical usage requirements of a tubular motor. In this embodiment, the speed reduction device 10 is a planetary gearbox, which provides smooth transmission, high load-bearing capacity, and a large transmission ratio within a compact space, making it suitable for tubular motor having also a small size.

The rear end of the motor body 2 is an input end of the motor body 2, and the input end is an end that connects to an electrical component assembly 20 of the tubular motor. The electrical component assembly 20 herein comprises electrical components which supply power and provide control to the motor body 2, such as a circuit board 201 and a power cord 202. This is a conventional technique and will not be further elaborated here. A first wire passage hole 51, a second wire passage hole 711, and a third wire passage hole 721, through which wires are arranged to connect the circuit board 201 with the motor body 2, are formed on the fixing seat 5, the third connecter 71, and the fourth connecter 72 respectively.

A plurality of first limiting plates 21 are provided around a peripheral edge of an end surface of the rear end of the motor body 2; second limiting grooves 712 corresponding to the first limiting plates 21 are formed circumferentially around an end portion of the third connecter 71 facing towards the motor body 2; the first limiting plates 21 are inserted into the second limiting grooves 712 respectively to achieve coaxial connection between the motor body 2 and the third connecter 71. In this embodiment, the first limiting plates 21 extend out of the motor body 2 and along an axial direction of the motor body 2 and surround an axis of the motor body 2 and spaced apart from one another by equal intervals.

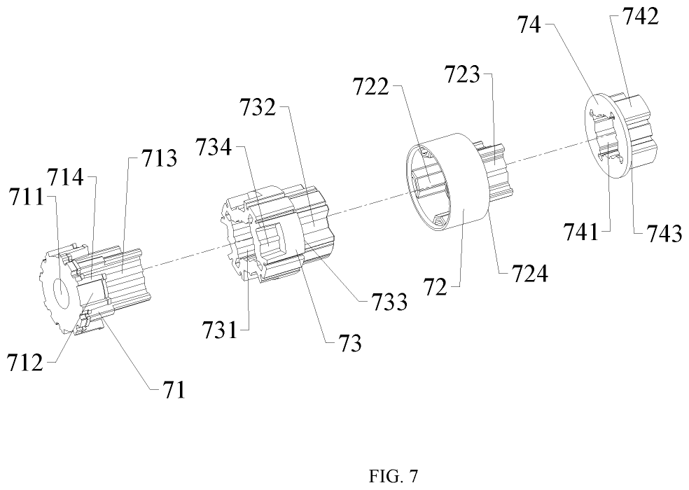

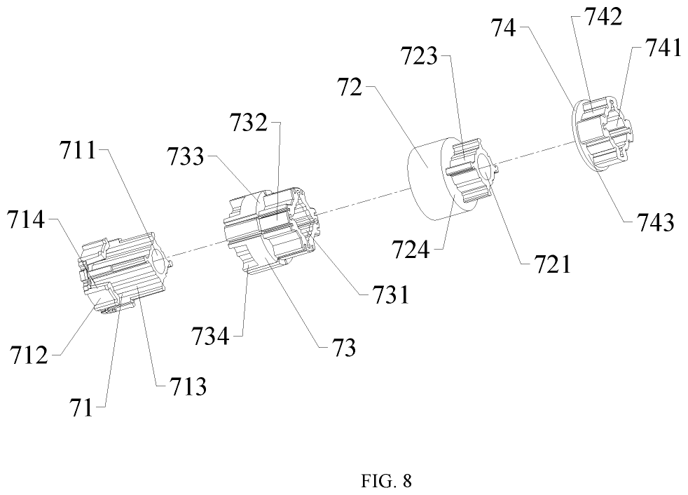

Referring to FIGS. 7 and 8, the third connecter 71 and the fourth connecter 72, as well as the fourth connecter 72 and the fixing seat 5, are in each case connected coaxially by spline connection. Therefore, the third buffer piece 73 sleeves on a spline head between the third connecter 71 and the fourth connecter 72, and a fourth buffer piece 74 sleeves on a spline head between the fourth connecter 72 and the fixing seat 5.

In some embodiments of the second damping assembly 7, a second spline head 713 is provided at one end of the third connecter 71 facing towards the fourth connecter 72; the second wire passage hole 711 extends through an end surface of the second spline head 713; a second spline hole 731 is formed at one end of the third buffer piece 73 facing towards the third connecter 71, and a third spline head 732 is provided at another end of the third buffer piece 73 facing towards the fourth connecter 72; and the second spline hole 731 extends through an end surface of the third spline head 732; a third spline hole 722 is formed at one end of the fourth connecter 72 facing towards the third connecter 71; the second spline head 713 is sleeved by the second spline hole 731, and the third spline head 732 is sleeved by the third spline hole 722.

Furthermore, a first stepped platform 733 is provided on the circumferential surface of the third buffer piece 73, the third spline head 732 protrudes from an end surface of the first stepped platform 733, and an end surface of the fourth connecter 72 abuts against the first stepped platform 733, thereby avoiding direct contact between the fourth connecter 72 and the third connecter 71, and therefore preventing rigid contact between the fourth connecter and the third connecter, which are both made of a hard materials. This effectively reduces vibration transmission and noise.

Further, a plurality of second limiting plates 714 are provided on a circumferential surface of the third connecter 71; third limiting grooves 734 corresponding to the second limiting plates 714 are formed on an end surface of the third buffer piece 73 facing towards the third connecter 71; the second limiting plates 714 are inserted into the third limiting grooves 734 respectively, thereby achieving position limiting effect between the third connecter 71 and the third buffer piece 73 both axially and circumferentially, and this can further enhance the coaxial connection strength between the third connecter 71 and the third buffer piece 73, and can also limit a depth which the second spline head 713 is inserted into the third buffer piece 73, and thus prevent rigid contact between the third connecter 71 and the fourth connecter 72. In this embodiment, the second limiting plates 714 extend along an outer side surface of the third connecter 71 in accordance with an axial direction of the third connecter 71, and surround an axis of the third connecter 71 and spaced apart from one another by equal intervals. Also, the second limiting grooves 712 are provided on outer side surfaces of the second limiting plates 714 respectively.

In some embodiments of the second damping assembly 7, a fourth spline head 723 is provided at one end of the fourth connecter 72 facing towards the fixing seat 5, and the third wire passage hole 721 extends through an end surface of the fourth spline head 723; a fourth spline hole 741 and a fifth spline head 742 are provided at two ends of the fourth buffer piece 74 respectively; the fourth spline hole 741 extends through an end surface of the fifth spline head 742; a fifth spline hole 52 is formed at one end of the fixing seat 5 facing towards the fourth connecter 72; the fourth spline head 723 is sleeved by the fourth spline hole 741, and the fifth spline head 742 is sleeved by the fifth spline hole 52.

Furthermore, a second stepped platform 724 is provided on a circumferential surface of the fourth connecter 72, and the fourth spline head 723 protrudes from an end surface of the second stepped platform 724; a third stepped platform 743 is provided on a circumferential surface of the fourth buffer piece 74, and the fifth spline head 742 protrudes from an end surface of the third stepped platform 743; an end surface of the fourth buffer piece 74 abuts against the second stepped platform 724, and an end surface of the fixing seat 5 abuts against the third stepped platform 743, thus avoiding direct contact between the fixing seat 5 and the fourth connecter 72, and therefore preventing rigid contact between the fixing seat and the fourth connecter, which are both made of a hard material. This effectively reduces vibration transmission and noise.

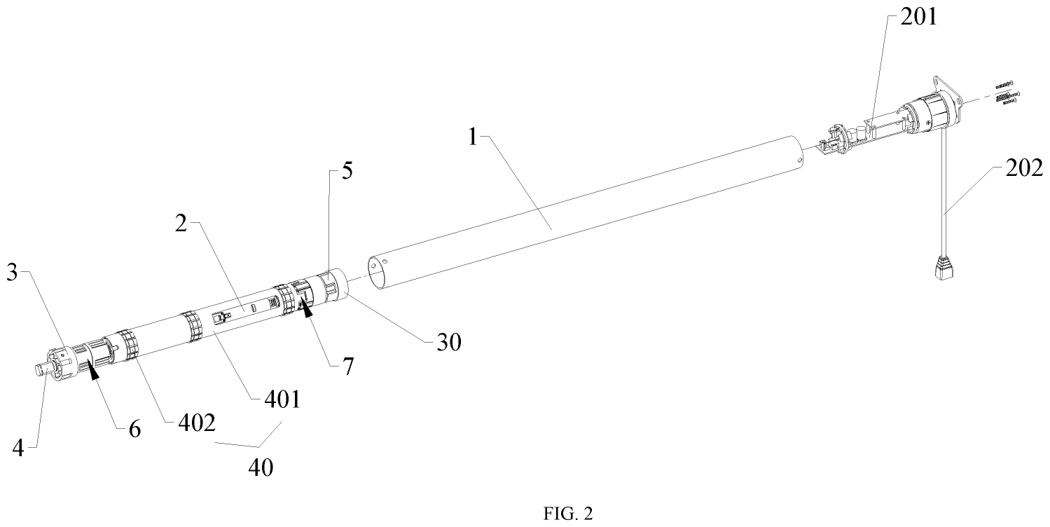

Referring to FIGS. 2, 4, and 11, a circumferential surface of the fixing seat 5 is sleeved with a first damping sleeve 30, and the first damping sleeve 30 is elastically fitted between the fixing seat 5 and the inner wall of the motor casing 1 to provide cushioning and vibration damping effects between the fixing seat 5 and the motor casing 1. Meanwhile, the frictional force between the first damping sleeve 30 and the fixing seat 5/motor casing 1 is utilized to stop rotation of the fixing seat 5 with respect to the inner wall of the motor casing 1, thereby achieving the purpose of securely fitting the fixing seat 5 within the motor casing 1.

A third damping assembly 40 is provided between a circumferential surface of the motor body 2 and the inner wall of the motor casing 1; the third damping assembly 40 comprises a sealing tube 401 sleeving around the circumferential surface of the motor body 2. This ensures that the noise generated during operation of the motor body 2 is contained within the sealing tube 401, thereby effectively reducing the noise.

Furthermore, the third damping assembly 40 further comprises a plurality of second damping sleeves 402 sleeving around a circumferential surface of the sealing tube 401; the second damping sleeves 402 are elastically fitted between the circumferential surface of the sealing tube 401 and the inner wall of the motor casing 1 and are configured to absorb the vibrations generated by the motor body 2 during operation, thereby preventing the motor body 2 from impacting (colliding) with the motor casing 1 and generating noise.

Next, fourth limiting grooves 4011 accommodating the second damping sleeves 402 respectively are formed on the circumferential surface of the sealing tube 401 and are configured to limit the installation positions of the second damping sleeves 402, thereby preventing any displacement of the second damping sleeves 402 caused by the vibrations generated during operation of the motor body 2 and ensuring the working stability of the second damping sleeves 402.

Moreover, a plurality of stripes 4021 oriented along the axial direction of the tubular motor are formed on the circumferential surface of each of the second damping sleeves 402, and the stripes 4021 are formed as protrusions or recesses on the circumferential surface of each of the second damping sleeves 402. Therefore, gaps in communication with an interior of the motor casing 1 are formed between each of the second damping sleeves 402 and the inner wall of the motor casing 1, and this can prevent the second damping sleeves 402 from being entirely attached to and in contact with the inner wall of the motor casing 1. As such, air inside the gaps can be utilized to reduce or eliminate noise.

Through the above solution, the present invention achieves cushioning and vibration damping effects by providing a first damping assembly 6 between the transmission shaft 8 and the output shaft 4 at the front end of the motor body 2 and a second damping assembly 7 between the rear end of the motor body 2 and the fixing seat 5. Both the first damping assembly 6 and the second damping assembly 7 are three-stage buffering connection structures. These structures are applied at both ends of the motor body 2 to provide cushioning and vibration damping effects during progressive power and motion transmission process and the process of components fixation and connection. Compared to the traditional structure where there are rigid connections and motion transmissions between the motor body 2, the output support 3, and the fixing seat 5, the three-stage buffering connection structures that provide elastic connection and motion transmission can effectively reduce or even eliminate vibrations at each stage of connection and motion transmission, preventing noise, thereby enhancing the noise reduction and vibration damping effect between the input end of the tubular motor and the motor casing. As a result, the quality of the tubular motor is improved and thus it can be used in scenarios where silent operation is required.

What is claimed is:

1. A noise reduction and shock absorption structure for a tubular motor, comprising a motor casing, a motor body, an output support, an output shaft, a fixing seat, a first damping assembly, and a second damping assembly;
the motor body is provided inside the motor casing; a front end of the motor body is connected to a transmission shaft to transmit motions;
the output support is embedded at a front end of the motor casing;
the output shaft is rotatable and passes through the output support;
the fixing seat is embedded within the motor casing;
the first damping assembly is provided between the transmission shaft and the output shaft; the second damping assembly is provided between a rear end of the motor body and the fixing seat;
the first damping assembly comprises a first connecter and a second connecter both made of hard materials, and a first buffer piece and a second buffer piece both made of soft materials; the transmission shaft, the first connecter, the second connecter, and the output shaft are connected coaxially in sequence; the first buffer piece is provided at a connecting portion between the transmission shaft and the first connecter, and the second buffer piece is provided at a connecting portion between the first connecter and the second connecter;
the second damping assembly comprises a third connecter and a fourth connecter both made of hard materials, and a third buffer piece and a fourth buffer piece both made of soft materials; the rear end of the motor body, the third connecter, the fourth connecter, and the fixing seat are connected coaxially in sequence;
the third buffer piece is provided at a connecting portion between the third connecter and the fourth connecter, and the fourth buffer piece is provided at a connecting portion between the fourth connecter and the fixing seat.

2. The noise reduction and shock absorption structure of claim 1, wherein the hard materials are metals or high-strength plastics; the soft materials are rubber and silicone.

3. The noise reduction and shock absorption structure of claim 1, wherein an input end of the first connecter is a first spline hole, and a circumferential surface of the transmission shaft is sleeved by a fifth connecter made of a hard materials; an outer shape of the first buffer piece matches with a shape of the first spline hole; an outer shape of the fifth connecter matches with a shape of an inner cavity of the first buffer piece, and an inner cavity of the fifth connecter matches with a shape of the transmission shaft.

4. The noise reduction and shock absorption structure of claim 1, wherein an output end of the first connecter is a first spline head, and a first spline groove corresponding to the first spline head is formed on the second buffer piece.

5. The noise reduction and shock absorption structure of claim 4, wherein an end surface of the second connecter facing towards the first connecter is recessed to form a second spline groove; an end of the second spline groove away from the first connecter is stepped to form a through hole in communication with the second spline groove for the output shaft to pass through; a limiting plate is provided at an end of the output shaft to abut against an end surface of the second buffer piece; first limiting grooves on which the limiting plate is slidable along an axial direction of the second spline groove are formed on side walls of the second spline groove; the first limiting grooves extend to the end of the second spline groove away from the first connecter.

6. The noise reduction and shock absorption structure of claim 4, wherein a length of the first spline groove is greater than a length of the first spline head.

7. The noise reduction and shock absorption structure of claim 1, wherein a shaft rotation hole is formed in the output support extending along an axis of the output support; the output shaft passes through the shaft rotation hole and is rotatable inside the shaft rotation hole; a plurality of damping rings are provided between a circumferential surface of the output shaft and an inner wall of the shaft rotation hole.

8. The noise reduction and shock absorption structure of claim 1, wherein a speed reduction device is provided on an output end of the motor body; an input end of the speed reduction device is connected with a rotating shaft of the motor body to achieve motion transmission; an output end of the speed reduction device is connected with the transmission shaft to achieve motion transmission.

9. The noise reduction and shock absorption structure of claim 1, wherein a plurality of first limiting plates are provided around a peripheral edge of an end surface of the rear end of the motor body; second limiting grooves corresponding to the first limiting plates are formed circumferentially around an end portion of the third connecter facing towards the motor body; the first limiting plates are inserted into the second limiting grooves respectively.

10. The noise reduction and shock absorption structure of claim 1, wherein a second spline head is provided at one end of the third connecter facing towards the fourth connecter; a second spline hole is formed at one end of the third buffer piece facing towards the third connecter, and a third spline head is provided at another end of the third buffer piece facing towards the fourth connecter; and the second spline hole extends through an end surface of the third spline head; a third spline hole is formed at one end of the fourth connecter facing towards the third connecter; the second spline head is sleeved by the second spline hole, and the third spline head is sleeved by the third spline hole.

11. The noise reduction and shock absorption structure of claim 10, wherein a first stepped platform is provided on a circumferential surface of the third buffer piece, the third spline head protrudes from an end surface of the first stepped platform, and an end surface of the fourth connecter abuts against the first stepped platform.

12. The noise reduction and shock absorption structure of claim 10, wherein a plurality of second limiting plates are provided on a circumferential surface of the third connecter; third limiting grooves corresponding to the second limiting plates are formed on an end surface of the third buffer piece facing towards the third connecter; the second limiting plates are inserted into the third limiting grooves respectively.

13. The noise reduction and shock absorption structure of claim 1, wherein a fourth spline head is provided at one end of the fourth connecter facing towards the fixing seat; a fourth spline hole and a fifth spline head are provided at two ends of the fourth buffer piece respectively; the fourth spline hole extends through an end surface of the fifth spline head; a fifth spline hole is formed at one end of the fixing seat facing towards the fourth connecter; the fourth spline head is sleeved by the fourth spline hole, and the fifth spline head is sleeved by the fifth spline hole.

14. The noise reduction and shock absorption structure of claim 13, wherein a second stepped platform is provided on a circumferential surface of the fourth connecter, and the fourth spline head protrudes from an end surface of the second stepped platform; a third stepped platform is provided on a circumferential surface of the fourth buffer piece, and the fifth spline head protrudes from an end surface of the third stepped platform; an end surface of the fourth buffer piece abuts against the second stepped platform, and an end surface of the fixing seat abuts against the third stepped platform.

15. The noise reduction and shock absorption structure of claim 1, wherein a circumferential surface of the fixing seat is sleeved with a first damping sleeve, and the first damping sleeve is elastically fitted between the fixing seat and an inner wall of the motor casing.

16. The noise reduction and shock absorption structure of claim 1, wherein a third damping assembly is provided between a circumferential surface of the motor body and an inner wall of the motor casing; the third damping assembly comprises a sealing tube sleeving around the circumferential surface of the motor body, and a plurality of second damping sleeves sleeving around a circumferential surface of the sealing tube; the second damping sleeves are elastically fitted between the circumferential surface of the sealing tube and the inner wall of the motor casing.

17. The noise reduction and shock absorption structure of claim 16, wherein fourth limiting grooves accommodating the second damping sleeves respectively are formed on the circumferential surface of the sealing tube.

18. The noise reduction and shock absorption structure of claim 16, wherein a plurality of stripes oriented along an axial direction of the tubular motor are formed on a circumferential surface of each of the second damping sleeves.
